(19) United States
(12) Patent Application Publication
(10) Pub. No.: US 2012/0272085 A1
(43) Pub. Date: Oct. 25, 2012

(54) SERVER SYSTEM WITH UNINTERRUPTIBLE POWER SUPPLY

(75) Inventors: HUNG-YI WU, Tu-Cheng (TW); LEI LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/117,147

(22) Filed: May 27, 2011

(30) Foreign Application Priority Data
Apr. 20, 2011 (CN) 201110099126.5

(51) Int. Cl. G06F 1/28

(52) U.S. Cl. 713/340

(57) ABSTRACT

A server system includes a rack, a power interface, an uninterruptible power supply (UPS), a number of first servers, and a second server. The power interface is configured to connect the server system to an input power source. The UPS is configured to provide emergency power to the server system on a condition that the input power source fails. Each first server is configured to process data when the server system is powered by the input power source and shut down properly immediately on a condition that the input power source fails. The second server is configured to back up the data in process of the first servers in real time when the server system is powered by the input power source and configured to back up its data in process and then shut down on a condition that the input power source fails.

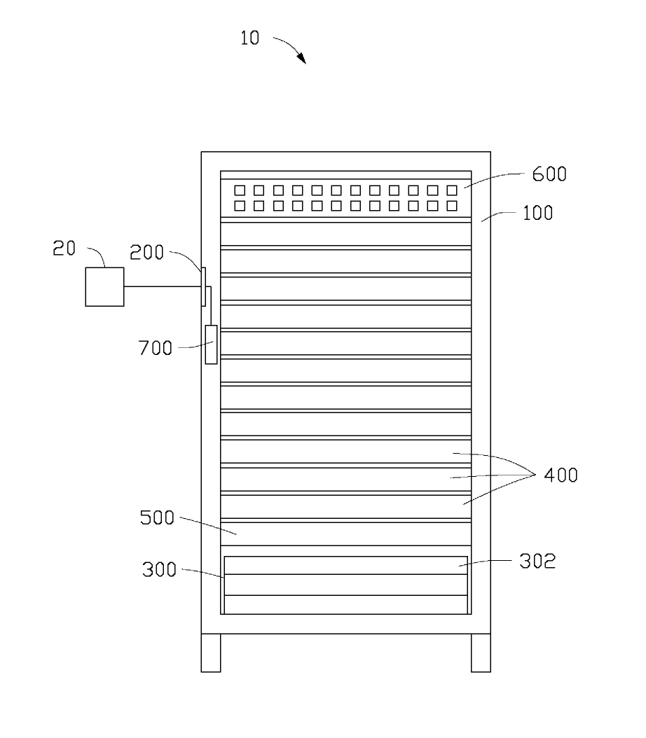

### BACKGROUND

1. Technical Field

The present disclosure relates to server systems and, particularly, to a server system having an uninterruptible power supply (UPS).

2. Description of Related Art

Server systems often include several servers and a UPS. The UPS usually includes storage batteries.

In normal operation, the server system is powered by an input power source and each server processes data. When the input power source fails, the UPS takes over, providing near-instantaneous power to the server system. Thus, the servers can back up the data in process and then shuts down properly in the on-battery runtime of the UPS to protect the data and the servers from being damaged.

To ensure that all of the servers can finish the data backup, the UPS needs to store a great amount of power. That is, the UPS needs to employ a great number of storage batteries. As a result, the UPS is relatively large in size and occupies most of the space of the server system, limiting the space for the servers.

Therefore, it is desirable to provide a server system, which can overcome the limitations described.

### BRIEF DESCRIPTION OF THE DRAWING

Many aspects of the present disclosure can be better understood with reference to the following drawing. The components in the drawing are not necessarily drawn to scale, the emphasis instead being placed upon clearly illustrating the principles of the present disclosure.

The FIGURE is a planar, schematic view of a server system, according to an embodiment.

### DETAILED DESCRIPTION

Embodiments of the present disclosure will now be described in detail with reference to the drawing.

Referring to the FIGURE, a server system 10, according to an embodiment, includes a rack 100, a power interface 200, an UPS 300, a number of first servers 400, and a second server 500. The UPS 300, the first servers 400, and the second server 500 are received in the rack 100. The power interface 200 is used to interface with an input power source 20. That is, the power interface 200 is configured to connect the server system 10 to the input power source 20. The UPS 300 is configured to provide near-instantaneous power to the server system 10 after the input power source 20 failed. Each first server 400 is configured to process data when the server system 10 is powered by the input power source 20 and shuts down immediately after the input power source 20 failed, that is, when the server system 10 is powered by the UPS 300. In other words, the first servers 300 shut down properly without backing up its own data in process after the input power source 20 failed. The second server 500 is configured to back up the data in process of the first servers 400 in real time when the server system 10 is powered by the input power source 20. The second server 500 is further configured to back up its own data in process and then shuts down properly immediately after the input power source 20 failed.

Therefore, the server system 10 require less power from the UPS 300 for the data backup and the shut-down, as compared with conventional server systems, because that only the second server 400 requires power from the UPS 300 for the data backup. Power storage capacity of the UPS 300 can be reduced. Thus, the size of the UPS 300 can be reduced too because that the power storage capacity of the UPS 300 is typically proportional to the size of the UPS 300. In this embodiment, the power storage capacity of the UPS 300 is substantially equal to or slightly higher than power demand of the first servers 400 for properly shutting down and the second server 500 for backing up its data in process properly shutting down.

The UPS 300 includes a number of storage batteries 302. The number of the storage batteries 302 is set such that the power storage capacity of the UPS 300 is substantially equal to or slightly higher than power demand of the first servers 400 for properly shutting down and the second server 500 for backing up its data in process and properly shutting down.

The UPS 300, each first server 400, and the second server 500 can detect whether or not the input power source 20 fails and act accordingly. In other embodiments, the server system 100 may further include a detector 700 to perform the detection, and signals the UPS 300, the first servers 400, and the second server 500 to react accordingly.

The detection can be carried out by measuring electric parameters, such as voltage values, of the power interface 200. For example, if the voltage value of the power interface 200 falls to about 0 volt, it is determined that the input power source 20 has failed.

The server system 10 further includes a switch 600. The first servers 400 and the second server 500 can communicate with each other via the switch 600, thus allowing the second server 500 to back up the data in process of the first servers 400.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A server system, comprising:
a rack;
a power interface configured to connect the server system to an input power source;
an uninterruptible power supply (UPS) configured to provide emergency power to the server system on a condition that the input power source fails;
a plurality of first servers, each of which is configured to process data when the server system is powered by the input power source and shut down properly immediately on a condition that the input power source fails; and
a second server configured to back up the data in process of the first servers in real time when the server system is powered by the input power source, the second server being further configured to back up its data in process and then shutting down immediately on a condition that the input power source fails.

2. The server system of claim 1, wherein the power storage capacity of the UPS is substantially equal to or slightly higher than power demand of the first servers for properly shutting down and the second server for backing up its data in processing and properly shutting down.

3. The server system of claim 1, wherein the UPS comprises a plurality of storage batteries.

4. The server system of claim 3, wherein the number of the storage batteries is set such that the power storage capacity of the UPS is substantially equal to or slightly higher than power demand of the first servers for properly shutting down and the second server for backing up its data in processing and properly shutting down.

5. The server system of claim 1, wherein the UPS is configured to detect whether or not the input power source fails.

6. The server system of claim 1, wherein each first server is configured to detect whether or not the input power source fails.

7. The server system of claim 1, wherein the second server is configured to detect whether or not the input power source fails.

8. The server system of claim 1, further comprising a detector, the detector being configured to detect whether or not the input power source fails and configured to signal the UPS, the first servers, and the second server to react accordingly.

9. The server system of claim 8, wherein the detector detects whether or not the input power source fails by measuring electric parameter of the power interface.

10. The server system of claim 8, wherein the power parameters comprises a voltage value.
